(19) United States
(12) Patent Application Publication
(10) Pub. No.: US 2010/0025314 A1
(43) Pub. Date: Feb. 4, 2010

(54) FLOATING DEBRIS TRAP SYSTEM

(75) Inventor: Chee Leong CHENG, Singapore (SG)

Correspondence Address: HORIZON IP PTE LTD, 7500A Beach Road, #04-306/308 The Plaza, SINGAPORE 199591, SG

(73) Assignee: ML INTERNATIONAL TRADING PTE LTD., Singapore (SG)

(21) Appl. No.: 12/512,028

(22) Filed: Jul. 30, 2009

Related U.S. Application Data
(60) Provisional application No. 61/084,627, filed on Jul. 30, 2008.

(51) Int. Cl. B01D 35/05

(52) U.S. Cl. 210/170.05

(57) ABSTRACT

A debris collection system is presented. The debris collection system includes a trap and first and second floating guides. The first ends of the floating guides are coupled to corners of the trap for keeping the trap on a surface of a waterway. A release mount is coupled to a second end of the second guide. The release mount enables release of the system, allowing navigation through the waterway while collecting debris.

### BACKGROUND

Waterborne pollutants, such as floating debris and trash, can collect in large bodies of water or along shorelines and beaches. The pollutants create environmental concerns, being a threat to wildlife and health. In addition, the pollutants can degrade the aesthetics of the environment, which can negatively affect the economy, such as decrease in tourism or property value.

Removing floating debris can be time consuming, tedious and costly. Floating debris collection systems have been proposed to ease the effort of collecting the debris. However, such systems have been ineffective. For example, conventional systems do not into take account of changing water levels. The changing water levels can create stress in conventional systems. Such stress can cause defects or breakage, rendering the systems ineffective.

From the foregoing discussion, it is desirable to improve collection of floating debris.

### SUMMARY

A debris collection system is presented. The debris collection system includes a trap and first and second floating guides. The first ends of the floating guides are coupled to corners of the trap for keeping the trap on a surface of a waterway. A release mount is coupled to a second end of the second guide. The release mount enables release of the system, allowing navigation through the waterway while collecting debris.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1a shows a top view of an embodiment of a floating debris collection system;

FIG. 1b shows a frontal view of a subsystem of a floating debris collection system;

FIG. 1c shows a frontal view of another subsystem of a floating debris collection system;

FIGS. 2a-b show side and top views of an embodiment of a floating mount of a floating debris collection system;

FIGS. 3a-b shows side and front views of a release mount of a floating debris collection system;

FIG. 4 shows a fixed mount of a floating debris collection system;

FIG. 5a shows boom linker and flexible joint of a floating debris collection system;

FIGS. 5b-c show another flexible joint and boom linker of a floating debris collection system; and

FIGS. 6a-b show front and side views of a debris trap.

### DETAILED DESCRIPTION

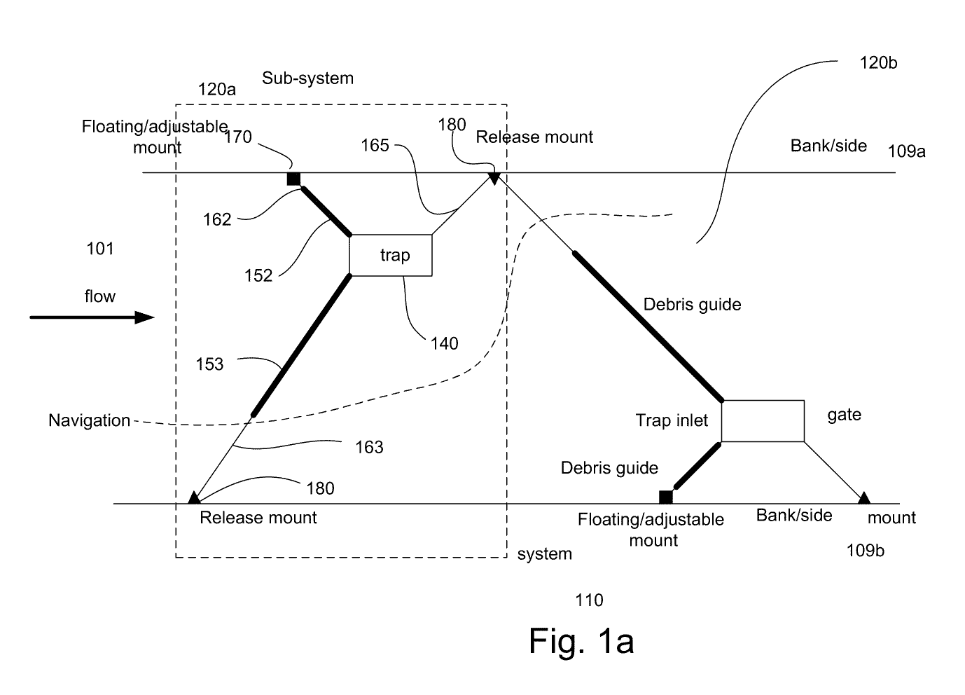

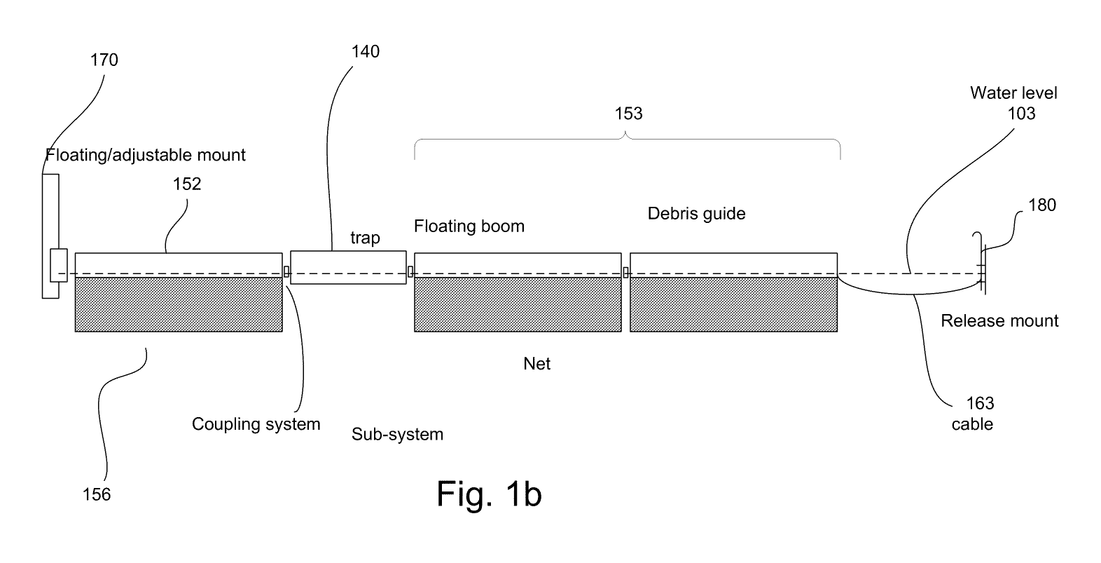

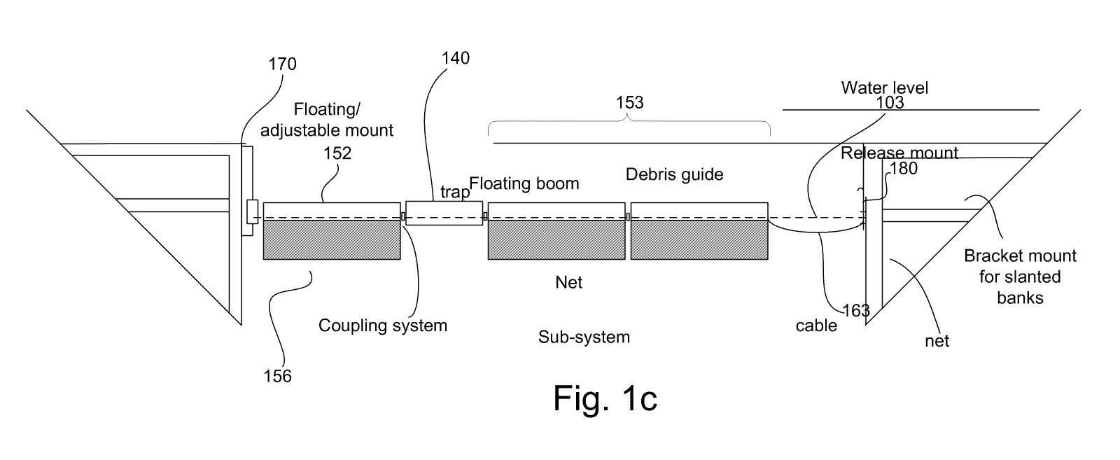

Embodiments generally relate to collecting floating debris. FIG. 1a shows a top view of an embodiment of a floating debris collection system 110. The system, for example, is installed in a waterway 101, such as a river or a canal. The system can also be installed in other types of waterways or bodies of water. The system can also be installed in a body of water or a portion thereof to collect floating debris. In one embodiment, the collection system comprises first and second subsystems 120a and 120b. FIG. 1b shows a frontal view of the first subsystem. The frontal view is, for example, from the perspective of the direction of flow. Providing a collection system with other number of subsystems, including 1, is also useful.

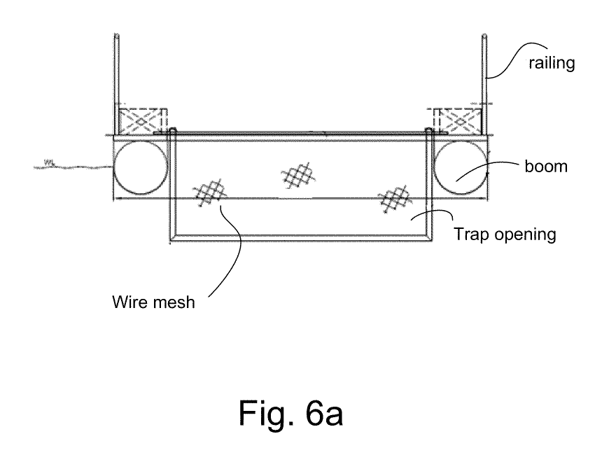

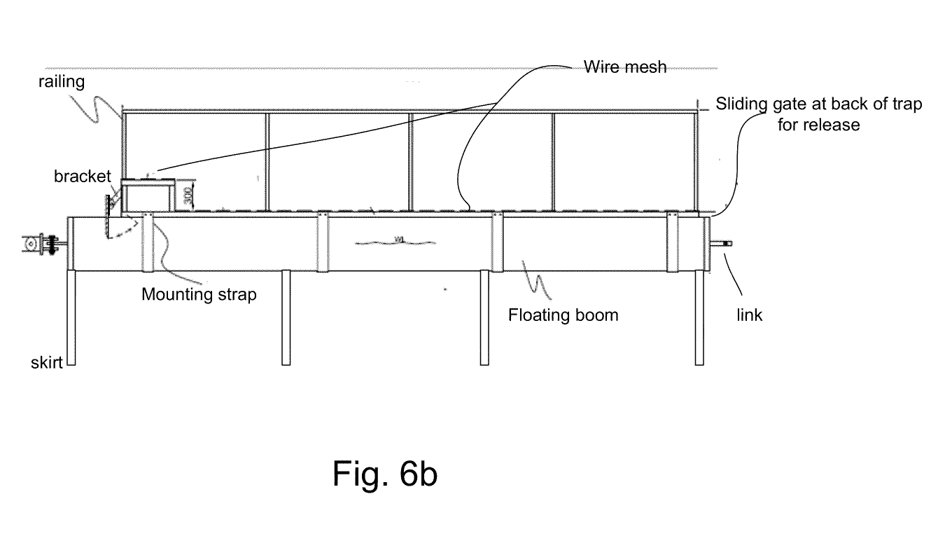

Referring to FIGS. 1a-b, a subsystem is coupled to first and second sides or banks 109a-b of the waterway. It is understood that the first and second sides or banks can also be part of a shore of a body of water. In other words, it is not necessary that the banks be distinct banks, but instead can be a contiguous bank. As shown, a subsystem includes a floating debris trap 140. Front and side views of the floating debris trap are shown in FIGS. 6a-b. The floating debris trap, for example, comprises a box frame. The box frame for example, is rectangular in shape. Other types of shapes are also useful. Wire meshing, for example, is attached to the frame. The wire meshing contains debris that flow into the trap from the front while allowing water to flow through trap. The trap includes floats attached to the frame. The float keeps the trap on the surface of the waterway to trap floating debris. The float, for example, comprises floating booms 152 and 153. Other types of floating debris traps can also be used.

In one embodiment, the first subsystem traps debris floating through a first portion of the waterway while the second subsystem traps debris floating through a second portion of the waterway. The trap of the first subsystem can be located from about 15-50% the width of the waterway from the first side and the trap is located from about 15-50% the width of the waterway from the second side. In another embodiment, the trap of the first subsystem can be located from about 20-35% the width of the waterway from the first side and the trap is located from about 20-35% the width of the waterway from the second side. Locating the traps at other distances from the sides is also useful.

Links are provided on the trap. The links facilitates coupling of the trap to other components of the system. In one embodiment, the links are located at the corners of the trap. Locating the links at other parts of the trap is also useful. Various types of coupling links can be used. In one embodiment, a link comprises a support plate with an opening. The support plate is mounted to the trap along a first plane. The first plane, in one embodiment, is parallel to the plane formed by surface of the water. Mounting the support plate along other planes, such as, vertical to the plane of the surface of the water is also useful.

First and second floating guides 162 and 163 are provided. The floating guides include first and second ends. The ends include links for coupling to other components of the system. The links, for example, can be the same or similar type of links provided for the trap. In one embodiment, the floating guide links comprise a support plate with an opening. Other types of links are also useful. The links of a floating guide can be aligned in the same plane. Aligning the links of a floating guide on different planes is also useful. For example, the link on the first and second ends can be aligned in perpendicular planes.

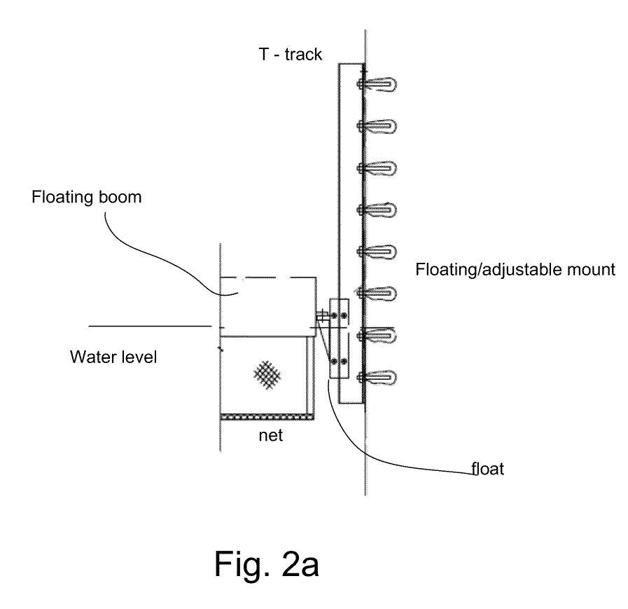

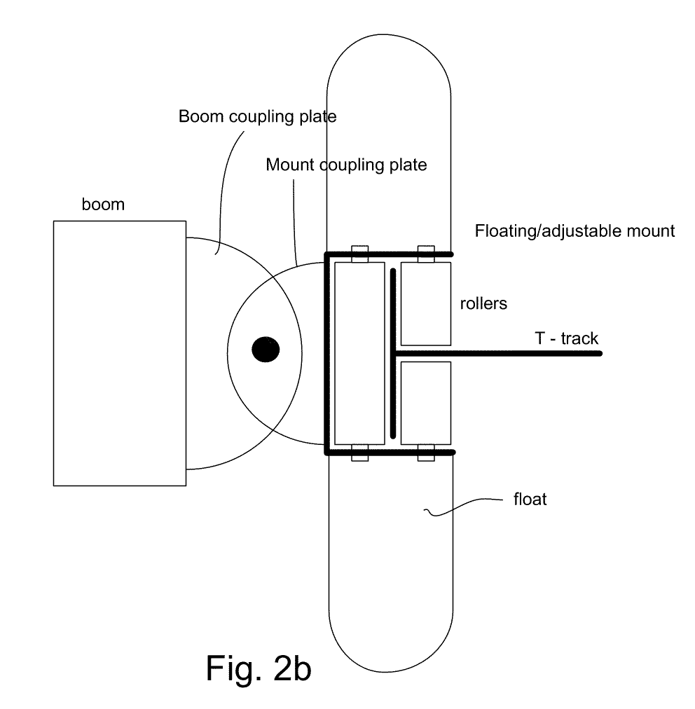

The first end of the first guide is coupled to the trap. In one embodiment, the first end of the first guide is coupled to the side of the trap which is located closest to a bank of the waterway. Preferably, the first end of the first guide is coupled to the front corner of the trap closest to a bank of the waterway. Coupling the first end to other parts of the trap is also useful. In one embodiment, the second end of the first guide is coupled to a floating/adjustable mount mounted on the bank. Side and top views of an embodiment of the floating/adjustable mount are shown in FIG. 2a-b. The floating/adjustable mount provides flexibility to position the floating debris collection system to desired level depending on the water level of the waterway. The second end of the first guide, in one embodiment, should be as close to the bank as possible to avoid floating debris from passing through it.

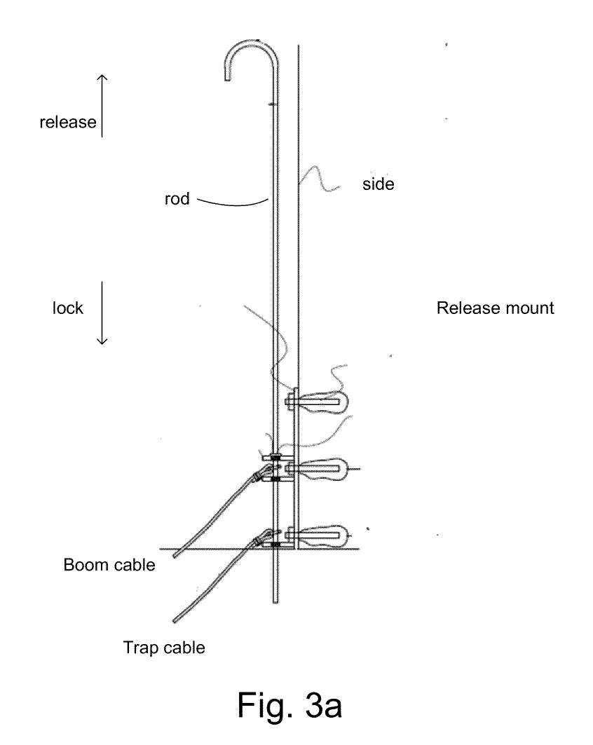

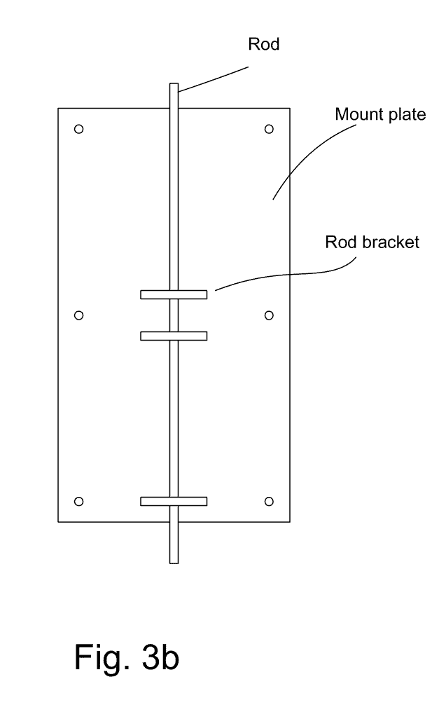

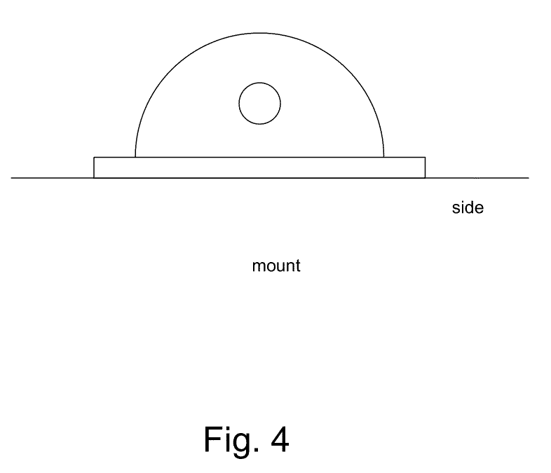

The first end of the second guide is coupled the trap. Preferably, the first end of the second guide is coupled to the side of the trap which is located farthest from a bank of the waterway. Preferably, the first end of the second guide is coupled to the front corner of the trap farthest away from a bank of the waterway. The second end of the second guide is coupled to a release mount mounted on a second side or bank of the waterway. Side and front views of an embodiment of the release mount are shown in FIGS. 3a-b. The release mount enables easy release of the collection system without affecting navigation through the waterway.

A first end of a guide is coupled to the trap. Preferably, the first end is coupled a link located at the front corner of the trap. Coupling the first end of the floating guide at other parts of the trap may also be useful. In one embodiment, the floating guide comprises a boom. Other types of floating guides are also useful. The boom floats on the surface of the water. In one embodiment, the boom comprises a polyethylene pipe. Forming booms from other types of materials are also useful. Typically, a floating boom is about 3000-6000 mm. Other lengths of the floating boom are also useful.

A second end of the boom is coupled to the side of the waterway. The first guide is coupled to the side which is closer to the trap. The second guide is coupled to the side farther from the trap. In one embodiment, the first guide extends to about the first side while the second guide extends to about the second side or bank of the waterway.

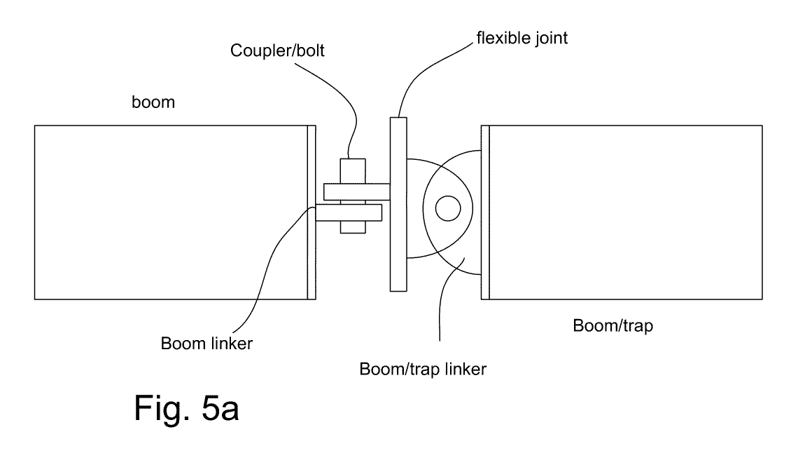

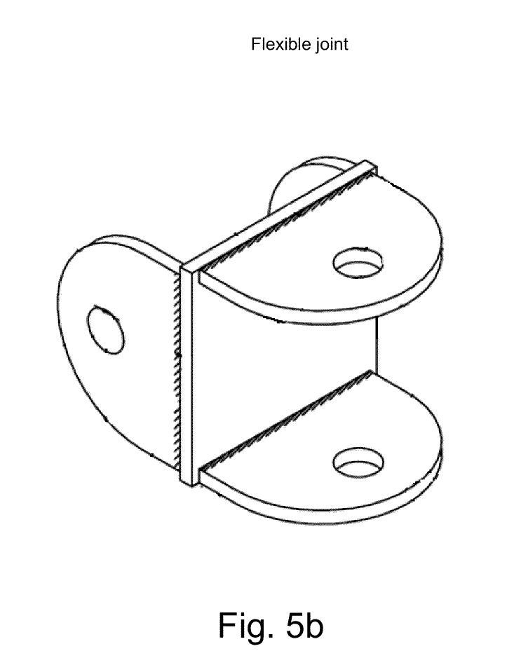

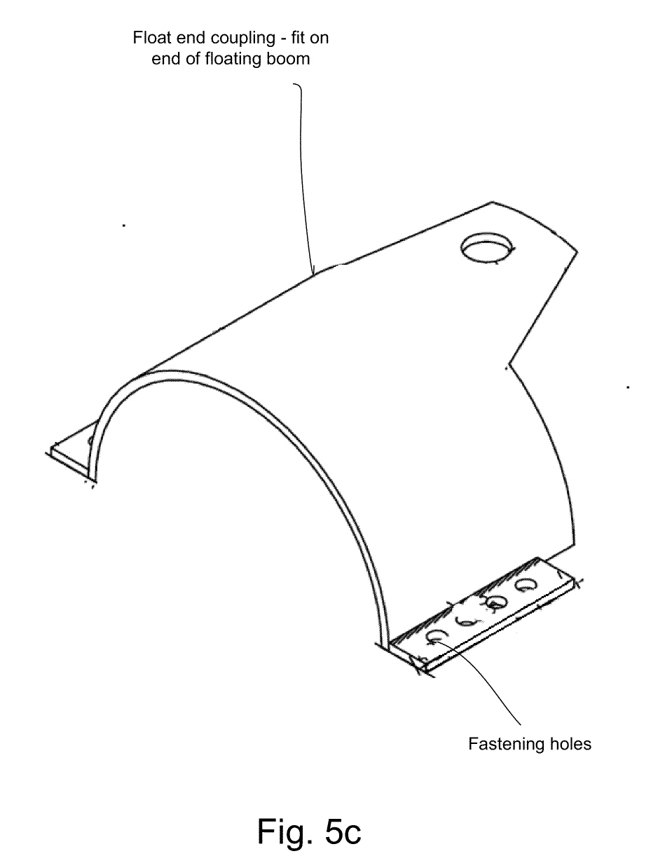

A floating guide can include a plurality of sub-guides coupled together. For example, a plurality of floating booms can be coupled together to form a floating guide of the desired lengths. Coupling of the plurality of the floating booms is achieved by providing a boom linker and a flexible joint at the ends of the booms. Various embodiments of the boom linker and flexible joint are illustrated in FIGS. 5a-c.

FIG. 1c shows a frontal view of another subsystem of a floating debris collection system. The subsystem is coupled to first and second sides or banks of the waterway. The banks, for example, are slanted banks. The system includes bracket mounts for coupling the system to the slanted banks. The subsystem as shown in FIG. 1c, similar to the one described in FIG. 1b, also includes a floating debris trap 140. Links are provided on the trap. The links facilitates coupling of the trap to other components of the system. In one embodiment, the links are located at the corners of the trap. Locating the links at other parts of the trap is also useful. Various types of coupling links can be used. In one embodiment, a link comprises a support plate with an opening. The support plate is mounted to the trap along a first plane. The first plane, in one embodiment, is parallel to the plane formed by surface of the water. Mounting the support plant along other planes, such as, vertical to the plane of the surface of the water is also useful.

The first end of the first guide is coupled to the front corner of the trap which is closest to the first bank. Preferably, the first end is coupled a link located at the front corner of the trap. Coupling the first end of the floating guide at other parts of the trap may also be useful. In one embodiment, the floating guide comprises a boom. Other types of floating guides are also useful. The boom floats on the surface of the water. In one embodiment, the boom comprises a polyethylene pipe. Forming booms from other types of materials are also useful. Typically, a floating boom is about 3000-6000 mm. Other lengths of the floating boom are also useful. A floating guide can include a plurality of sub-guides coupled together. For example, a plurality of floating booms can be coupled together to form a floating guide of the desired lengths.

A second end of the first guide is coupled to a bracket mount mounted to the first slanted bank of the waterway. The first guide is coupled to the side which is closer to the trap. The second guide is coupled to another bracket mount mounted to the side farther from the trap. In one embodiment, the first guide extends to about the first side while the second guide extends to about the second slanted bank of the waterway.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A debris collection system comprising:
a trap;
first and second floating guides, first ends of the floating guides coupled to corners of the trap for keeping the trap on a surface of a waterway; and
a release mount coupled to a second end of the second guide, wherein the release mount enables release of the system, allowing navigation through the waterway while collecting debris.

2. The debris collection system of claim 1 comprises an adjustable mount coupled to a second end of the first guide.

3. The debris collection system of claim 2 wherein the adjustable mount is mounted to a first side of the waterway and the release mount is mounted to a second side of the waterway.

4. The debris collection system of claim 1 wherein the floating guides comprises floating booms.

5. The debris collection system of claim 4 wherein the floating booms are coupled together by a boom linker and a flexible joint.

6. The debris collection system of claim 4 wherein the boom comprises polyethylene pipe.

7. The debris collection system of claim 1 wherein the trap comprises a frame.

8. The debris collection system of claim 7 wherein the trap comprises wire mesh attached to the frame.

9. The debris collection system of claim 1 wherein the trap comprises a plurality of links at the corners of the trap.

10. The debris collection system of claim 9 wherein the link comprises a support plate with an opening.

11. The debris collection system of claim 1 comprises first and second bracket mounts mounted to first and second side of the waterway.
